(19) United States
(12) Patent Application Publication
(10) Pub. No.: US 2012/0021372 A1
(43) Pub. Date: Jan. 26, 2012

(54) DENTAL HAND PIECE WITH DIRECTIONAL GUIDER CROSS REFERENCE TO RELATED APPLICATION

(76) Inventors: Chun-Leon CHEN, Taipei City (TW); Jennifer Cha, Las Vegas, NV (US)

(21) Appl. No.: 13/251,219

(22) Filed: Oct. 1, 2011

Related U.S. Application Data
(63) Continuation-in-part of application No. 12/366,850, filed on Feb. 6, 2009.

(51) Int. Cl. A61C 19/055; A61C 3/02

(52) U.S. Cl. 433/29

(57) ABSTRACT

A dental hand piece includes a reference line generator attachable to the face of a patient to generate a reference line in parallel to the top surfaces of the teeth of the patient, and a directional guider, for example, laser guider located on the front end of the hand piece body for generating a horizontal light beam for alignment with the reference line and a vertical light beam for indicating the hole-drilling position to help the dentist in drilling a hole perpendicular to the occlusal surface for accurate installation of a fixture to assure a successful dental implantation surgery.

### CROSS REFERENCE TO RELATED APPLICATION

The present invention is a continuation-in-part of U.S. patent application Ser. No. 12/366,850.

### BACKGROUND OF THE INVENTION

1. Field of the Invention

The present invention relates to a dental implement technology and more particularly, to a dental hand piece, which is equipped with a directional guider at the front side thereof for guiding the direction of drilling.

2. Description of the Related Art

A dental hand piece is a requisite tool in dental therapy for grinding a tooth in the oral cavity of a patient, or drilling a hole in the jawbone. More particularly, a dental hand piece is used during a dental implant surgery to drill a hole in a jawbone having the natural tooth lost for the installation of a screw shape fixture. After the fixture fuses with the jawbone, an abutment is affixed to the fixture at the top side with a screw, and then an artificial tooth crown is mounted at the abutment.

Referring to FIG. 1, an area having a natural tooth lost on a jawbone 31 in the oral cavity 3 of a patient between two teeth 33 may be recessed to form a concave indentation 32. When using a conventional dental hand piece 9 to drill a hole in the jawbone 31, the hole 34a drilled by the dentist may be not perpendicular to occlusal surface and deviated from the correct hole 34b. Thus, the fixture will be tilted after installation in the hole 34a, affecting further artificial tooth crown installation and resulting in an implantation failure. Therefore, an improvement in this regard is necessary.

### SUMMARY OF THE INVENTION

The present invention has been accomplished under the circumstances in view. It is the main object of the present invention to provide a dental hand piece, which has directional guider to guide accurate hole drilling, facilitating further accurate dental implantation surgery.

To achieve this and other objects of the present invention, a dental hand piece comprises a reference line generator, which comprises a transmitter and a receiver attachable to the surface of a patient to make a reference line on the surface of the patient in parallel to the top surface of the crowns of the teeth of the patient, a hand piece main body, which comprises a handle for holding by a dentist, a spinning mandrel perpendicularly extended from a front end of the handle and a drill located on the distal end of the spinning mandrel for grinding a tooth, and a directional guider mounted in the front end of the handle and controllable to generate at least one horizontal light beam for alignment with the reference line made on the surface of the patient by the reference line generator and one vertical light beam for indicating a hole-drilling position at a jawbone of the patient. Subject to the functioning of the directional guider and the reference line generator, a dentist can drill a hole on a jawbone accurately for fixture implantation, raising the success rate of dental implant surgery.

### BRIEF DESCRIPTION OF THE DRAWINGS

FIG. 1 is a schematic sectional view showing an error easily induced in drilling with a conventional dental hand piece.

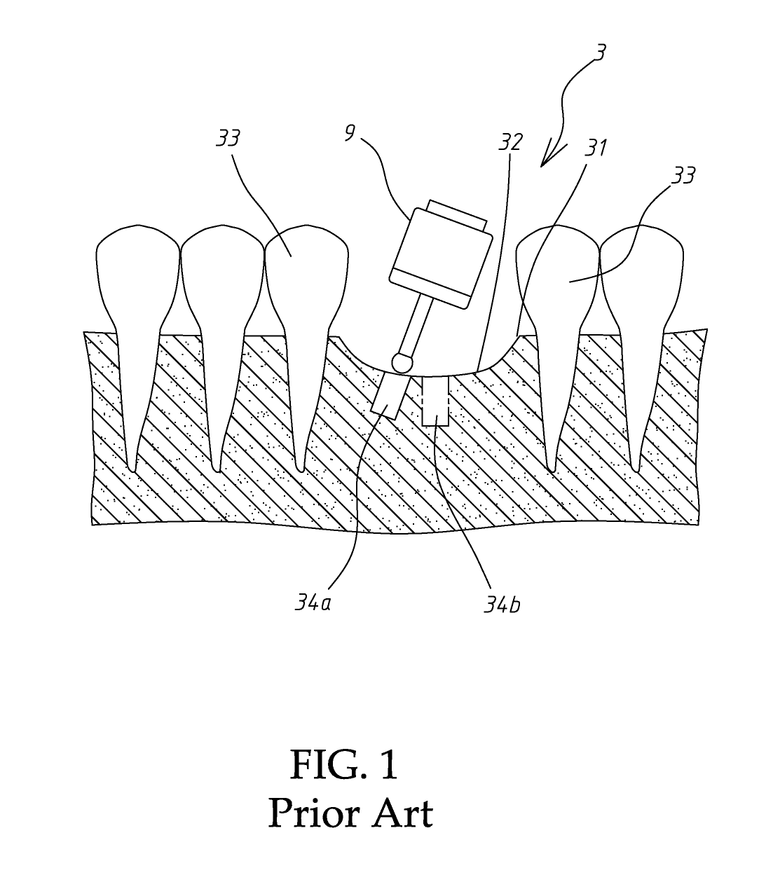

FIG. 2 is a plan view of a dental hand piece in accordance with the present invention.

FIG. 3 is a schematic sectional view illustrating a status of use of dental hand piece in accordance with the present invention

FIG. 4 is a schematic drawing illustrating a reference line generator attached to the face of a patient in accordance with the present invention.

### DETAILED DESCRIPTION OF THE PREFERRED EMBODIMENT

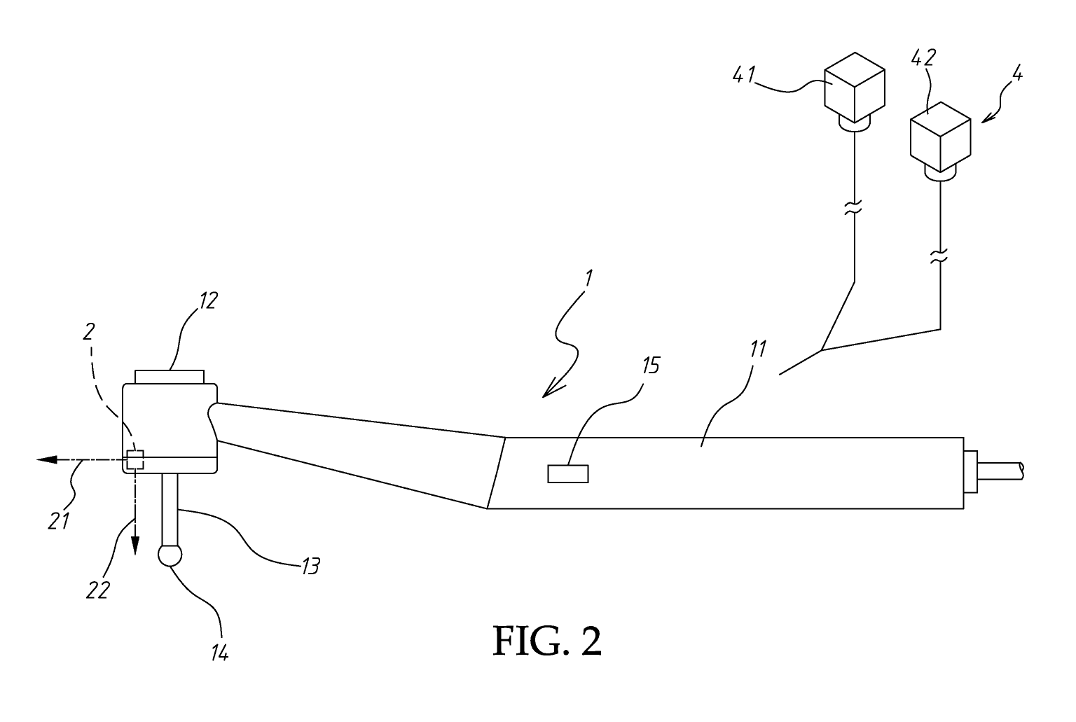

Referring to FIG. 2, a dental hand piece provided with a direction indication unit of the present invention comprises a hand piece main body 1, a directional guider 2 and a reference line generator 4.

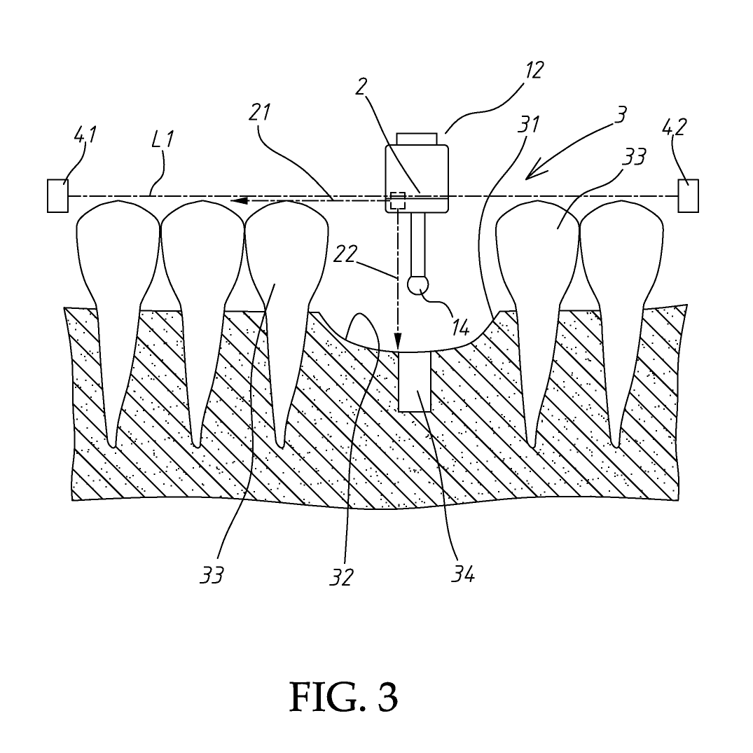

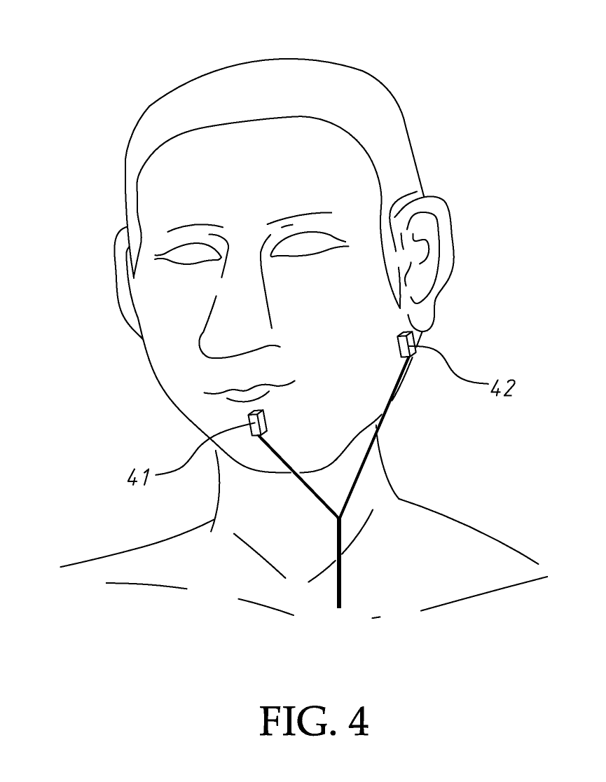

The reference line generator 4 comprises a transmitter 41 and a receiver 42 for attaching to the surface of the face of a patient (see FIG. 4) to generate a reference line L1 in parallel to the top surfaces of the crowns of the teeth 33 of the patient, as shown in FIG. 3.

The hand piece main body 1 is identical to the hand piece main body of a conventional dental hand piece, comprising a handle 11 to be held by a dentist, a spinning mandrel 13 perpendicularly extended from the front end 12 of the handle 11, and a drill 14 located on the distal end of the spinning mandrel 13 for grinding a tooth. The main feature of the present invention is the arrangement of the directional guider 2 at the front end 12 of the hand piece main body 1. The directional guider 2 is controllable to generate at least a horizontal light beam 21 and a vertical beam 22. The horizontal light beam 21 can be aligned with the reference line L1. The vertical light beam 22 is adapted for indicating the position of the hole to be drilled on a jawbone, and guiding the drill 14 to drill in a direction perpendicular to the biting surface. The horizontal light beam 21 and vertical beam 22 generated by the directional guider 2 can be laser beams or any other visible light beams without making hurt. Further, a switch 15 is mounted at the handle 11 of the hand piece main body 1, and switchable to turn on/off the directional guider 2.

Referring to FIG. 3, when going to drill a hole 34 on a plain area of a jawbone 31 in the oral cavity 3 for implanting a fixture, the jawbone 31 having the natural tooth lost may wilt to form a down arched dented portion 32. At this time, the dentist can attach the transmitter 41 and the receiver 42 of the reference line generator 4 to the surface of the face of the patient to generate a reference line L1 in parallel to the surfaces of the crowns of the adjacent teeth 33, and the switch on the switch 15, causing the directional guider 2 to generate a horizontal light beam 21 and a vertical beam 22, and adjust the position of the hand piece main body 1 to keep the horizontal light beam 21 in alignment with the reference line L1, thus the vertical light beam 22 can indicate the correct direction guide the dentist in attaching the drill 4 to the jawbone 31 to drill a hole 34 perpendicular to the occlusal surface for accurate fixture implantation, thereby greatly raising the success rate of dental implant surgery.

Although a particular embodiment of the invention has been described in detail for purposes of illustration, various modifications and enhancements may be made without departing from the spirit and scope of the invention.

What the invention claimed is:

1. A dental hand piece, comprising:
a reference line generator comprising a transmitter and a receiver attachable to the surface of a patient to make a reference line on the surface of the patient in parallel to the top surface of the crowns of the teeth of the patient;
a hand piece main body comprising a handle for holding by a dentist, a spinning mandrel perpendicularly extended from a front end of said handle and a drill located on a distal end of said spinning mandrel for grinding a tooth; and
a directional guider mounted in the front end of said handle and controllable to generate at least one horizontal light beam for alignment with the reference line made on the surface of the patient by said reference line generator and one vertical light beam for indicating a hole-drilling position at a jawbone of the patient.

2. The dental hand piece as claimed in claim 1, wherein said horizontal light beam is a laser light beam.

3. The dental hand piece as claimed in claim 1, wherein hand piece main body further comprises a switch operable to turn on/off said directional guider.
